(19) United States
(12) Patent Application Publication
(10) Pub. No.: US 2006/0206245 A1
(43) Pub. Date: Sep. 14, 2006

(54) Creation of use of flight release information

(76) Inventors: Mark Hemming Camper, Lexington, KY (US); Wendell Douglas Frazier, Mt. Sterling, KY (US); Edward Barsikh Ghazalian, Lexington, KY (US); Craig Anthony Rudolph, Shelbyville, KY (US); John Samuel Steele, Lexington, KY (US)

Correspondence Address: Christine Garcia;Lexmark International, Inc., 740 West New Circle Road, Lexington, KY, 40550, US

(21) Appl. No.: 11/074,458

(22) Filed: Mar. 8, 2005

(51) Int. Cl. G06F 17/00

(52) U.S. Cl. 701/3

(57) ABSTRACT

A network architecture and related controls for disseminating and capturing flight release documents permit user directed printing and transmitting functions. At a flight origination location, a user may be authorized based on inputted identification and prompted for a flight specific data item such as a flight number. Upon validating the flight specific data item, the relevant flight information is located and a flight release document containing the relevant flight information is created and produced at the flight origination location. At a flight destination location, users may be prompted again for identification and the flight release document may be captured, received, and stored. The produced flight release document may include a specific page number and a total page count on each printed sheet and may also include a barcode containing metadata related to the flight release document. The barcode may be scanned to determine certain details of the flight release document.

### BACKGROUND

The ability to gather information, which may be performed at a central hub, and distribute it to a network of users is an important business requirement. Distributing the information in an effective manner, and ensuring that the information is correct and complete provides many challenges.

The central hub gathers the information that is disseminated downward to the network of users. The information may be static information that does not change such as historical information, maps, laws and regulations, etc. Other information may be constantly changing such as financial information or weather. The central hub may also be geographically distanced from one or all of the network of users which may further complicate the process. Once gathered, the information is disseminated to the network of users. Each user receives the information and reviews it accordingly. Often times the user prints a hard copy of the information.

One example of a central hub is a strategic operation center used by the airline industry for flight release information. The information may include various necessary details about each flight, such as routing, gate, passenger list, baggage, fuel load, cargo load, hazardous material contents, special passenger requirements, and weather information. This information is created at a strategic operation center that is remotely located from one or more airports in the network.

Prior to each flight, an airline personnel accesses the network and prints a copy of the flight release information. This information is received prior to the flight leaving the airport. Potential issues that have occurred in the past is the ability to print a complete copy of the information, and to ensure that it is updated, particularly with regards to the constantly changing information. Further, the information on the network should be secure such that unauthorized persons do not have access.

### SUMMARY

Embodiments of the present invention are related to the distribution and subsequent capture of flight release information. At a flight origination location, users may be authorized based on an origination device input. The authorized user may be prompted for a flight specific data item such as a flight number or a destination location, which is validated. If the data item is not validated, the user may be prompted to receive outside assistance. If the data item is validated, the relevant flight information is located and a flight release document containing the relevant flight information is created and printed at the flight origination location. The relevant flight information may be stored in a remote location and may comprise separate data files containing weather information or flight details. The printed flight release document may include a specific page number and a total page count on each printed page of the document. The printed flight release document may also include a cover sheet having a barcode containing metadata related to the flight release document.

At the completion of a flight, and at the flight destination location, a user may be prompted at a destination device for identification. If verified, the flight release document may be received and stored using the destination device. In one embodiment, the flight release document is scanned by the destination device and transmitted to a remote location. Furthermore, if the flight release document comprises a barcode on the flight release document, metadata may be extracted by scanning the barcode. A confirmation may be produced at the flight destination location.

### BRIEF DESCRIPTION OF THE DRAWINGS

FIG. 1 is a schematic illustration of an airline information network according to one embodiment of the present invention;

FIG. 2 is a schematic illustration of a network architecture according to one embodiment of the present invention;

FIG. 3 is a flow diagram describing steps related to creating flight release information according to one embodiment of the present invention;

FIG. 4 is a schematic illustration of a network architecture according to one embodiment of the present invention;

FIG. 5 is a flow diagram describing steps related to capturing flight release information according to one embodiment of the present invention;

FIG. 6 shows an exemplary multifunction device for use in one embodiment of the present invention;

FIG. 7 is a diagram of an exemplary user interface for use in one embodiment of the present invention; and

FIG. 8 is a diagram of an exemplary user interface for use in one embodiment of the present invention.

### DETAILED DESCRIPTION

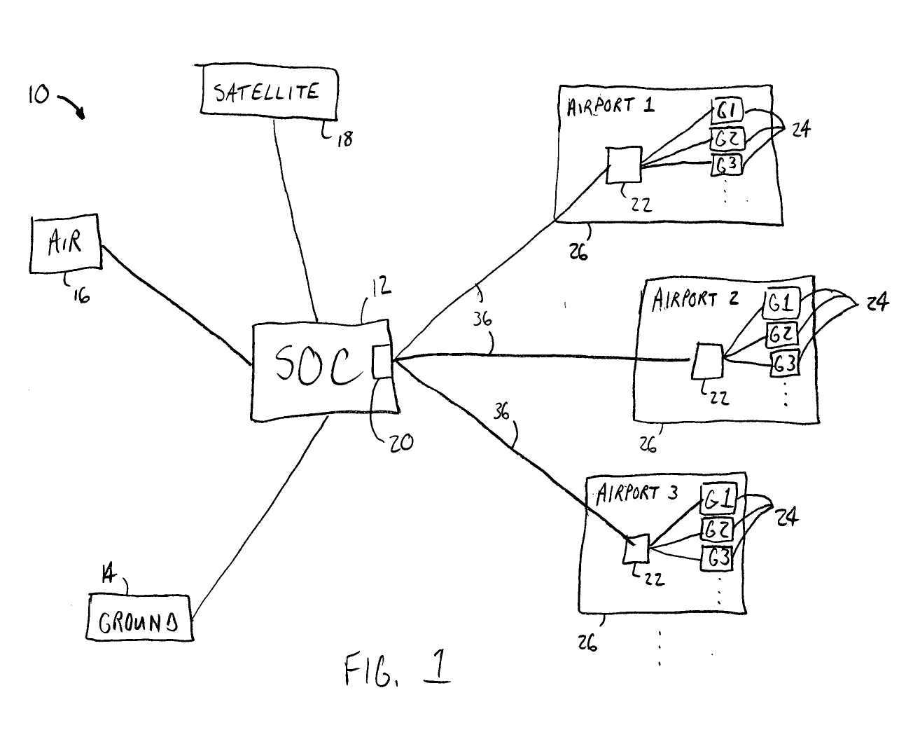

Embodiments of the present invention are directed to the dissemination and retrieval of flight release information in an airline industry network. One example of this type of airline network is indicated generally by the number 10 in FIG. 1. Airlines have a part of their organization that is responsible for the planning and operation of that airline's flights called the Airline System or Strategic Operations Center (SOC) 12. The SOC 12 operates around the clock and is responsible for overseeing the management of an airline's daily flights, tens of thousands of passengers and hundreds of flight crews. The SOC 12 includes dispatchers who plan the routes for individual flights based on a consideration of all available information, such as forecast weather, traffic, and travel near restricted areas. Dispatchers at the SOC 12 use information from a variety of sources, including ground observers 14 at a plurality of locations, including airports around the country, air observations 16, such as communications with pilots in flight, and satellite information 18, such as for weather conditions. Dispatchers at the SOC 12 constantly monitor flights conditions to handle unexpected events or emergencies. These dispatchers use application and file servers 20 at the SOC 12 to produce flight plans, daily flight schedules, aircraft routing, weather monitoring, tracking of aircraft, and maintenance information.

One task of the SOC 12 is to disseminate FAA required flight plans, also known as a Flight Release Packets, to pilots pre-flight. The flight release information contains information such as routing, gate, passenger list, baggage, fuel load, cargo load, haz-mat cargo, special passenger requirements, and weather information. This flight release information is transmitted over a combination of networking systems 36 including the airline's own network and other proprietary networks such as those operated by EDS, Sabre, SITA, and Airlink. Conventional solutions for disseminating flight release information operate on a push architecture where the SOC 12 transmitted the flight release packets to specific printers at a hub 22 or gate 24 at an appropriate airport 26. In contrast with this conventional approach, embodiments disclosed herein permit a pull-type architecture allowing pilots to access the flight release packets on-demand from a variety of locations, including at airport hubs 22, departure gates 24, pilot briefing rooms (not shown), or other suitable secure areas.

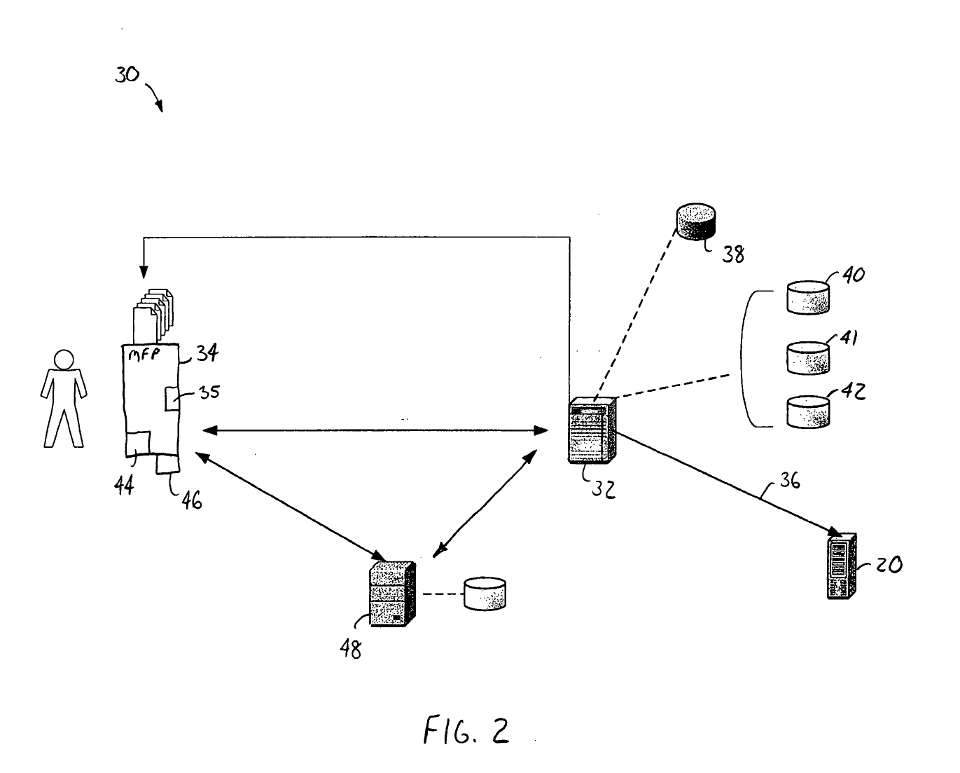

The exemplary network architecture 30 shown in FIG. 2 advantageously permits this type of on-demand flight release packet printing. At the core of this architecture 30 is a document distribution server 32 adapted to manage the dissemination and subsequent retrieval of the flight release packets. The document distribution server 32 may be a dedicated rack type, desktop type, or other computer running an appropriate document distribution application, such as the Lexmark Document Distributor, a document-routing application that can accept information directly from a multi-function printer 34, end-user workstations, or from other document servers, such as file server 20. The Lexmark Document Distributor application is available as part of the Lexmark Document Solutions Suite available from Lexmark International, Inc. in Lexington, Ky., USA.

The document distribution server 32 is adapted to access flight release packet information from an SOC file server 20 located at the remote SOC 12 location. The document distribution server 32 may be advantageously located at individual airports 26 accessible by a plurality of multifunction printers 34. The document distribution server 32 may alternatively be located at the SOC 12 or at intermediate locations (not shown). The document distribution server 32 accesses information on the SOC file server over a network 36 such as those described above. In one embodiment, the network 36 is a TCP/IP network and the document distribution server 32 and the flight release packet information is accessible through a secure application via a file transfer protocol (FTP) file sharing scheme. Alternative embodiments may employ other transfer schemes such as secure HTTP or secure shell SSH.

In one embodiment, flight release information is stored on the SOC file server 20 in plain text format ending in a .txt extension. The information may be divided over a plurality of files. For instance, one file may have flight-specific information and may be saved with a file name conforming to the format “flightnumber.data.txt” while a separate file having weather-specific information may be saved to a file having a name conforming to the format “flightnumber.weather.txt.” The document distribution server 32 is adapted to handle a plurality of different file formats so the .txt extension represents one of a plurality of possible formats. For instance the flight release information may be stored on the SOC file server 20 in a compressed format to improve transfer speeds to the document distribution server 32. However, the text format advantageously permits simple parsing and combining of the information contained within the data files. Furthermore, the data files are advantageously updated on a frequent basis to ensure that when the flight release packets are printed, the most up-to-date information is retrieved.

The exemplary architecture shown in FIG. 2 further comprises encryption services 38 that enables the printing of host encrypted data at the multifunction printer 34. The encryption services 38 allow the multifunction printer 34 to decrypt print jobs that are encrypted by the document distribution server 32. In one embodiment, the encryption services 38 comprises an application running on the document distribution server 32 that negotiates a secure session key with the printer, which has a corresponding decryption card that analyses the data stream and decrypts the data if a matching key is detected.

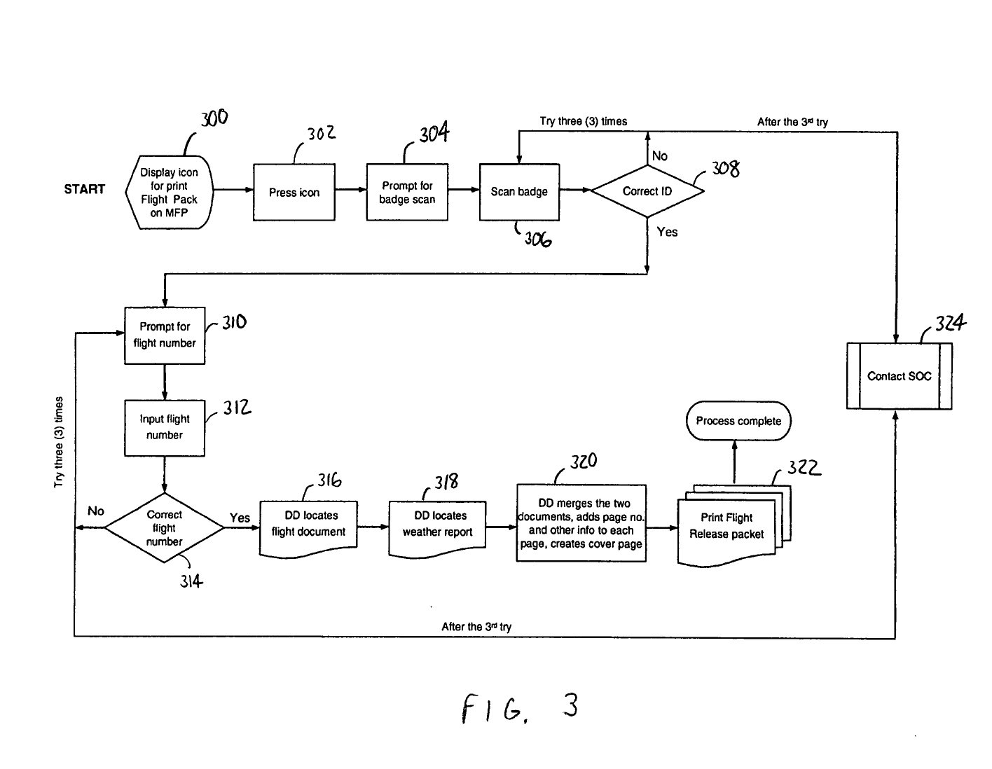

Various other modules 40-42 associated with the document distribution server 32 permit secure and reliable transfer of the flight release packet information from the document distribution server 32 to the multifunction printer 34. Each module 4042 is described below in the context of the procedure followed by users and the processes executed by processing circuitry 35 to access and print the desired flight release packet, which is shown in FIG. 3.

Referring to FIGS. 2 and 3, users such as pilots or other qualified personnel approach the multifunction printer 34 and select an option on display panel 44 to print the flight release. In one embodiment, users may select this particular option by selecting an icon (Steps 300, 302) on the display panel 44. The multifunction printer 34 is equipped with a proximity reader 46 made operable by card swipe module 42 and adapted to recognize an ID badge (not shown) given to qualified personnel. Thus, when the user enters a request to print the flight release, the multifunction printer 34 prompts the user to scan their ID badge (Step 304). The user places his/her badge against the proximity reader 46 (Step 306) and the multifunction printer 34 and/or the document distribution server 32 authenticates (Step 308) the badge information against the organization's personnel database stored locally or in a remote server 48. The database may be a Lightweight Directory Access Protocol (LDAP) database, which is an Internet protocol often used by email programs to look up contact information from a server. Alternatively, identification information may be verified using an Open DataBase Connectivity (ODBC) database, which provides access to data sources, such as SQL servers and any data source with an ODBC Driver. Other database standards known by those skilled in the art may be used as well.

In the event a badge is not initially recognized, the user may be prompted a predetermined number of times, such as three, to rescan the badge. Once the ID badge is validated at the multifunction printer 34, the user may be prompted for additional information such as a flight number (Step 310), a password, or other relevant information. Once all information is input (Step 312) and verified (Step 314), the document distribution server 32 locates the relevant flight release data files (Step 316) and weather files (Step 318) on the SOC file server 20, parses the information within the data files using a parse module 41 and extracts the data for compilation into a single report. More specifically, the document distribution server 32 extracts flight number, date, origin, and destination information from predefined locations or coordinates contained within the data files and merges the data and weather files to a single file (Step 320) that is delivered to the multifunction printer 34 (Step 322). FIG. 3 also shows that if a user badge or the flight number (or other input data) is not recognized in the predetermined number of attempts, the user is prompted to contact the SOC directly (Step 324).

In addition, the document distribution server 32, having a knowledge of the total number of pages contained in the merged document, inserts page information and flight information as a header or footer on each page of the merged document. Furthermore, the page number information includes a total number of pages so that the page number appears in the form “Page X of Y” where X is the current page number and Y is the total number of pages in the document. With the flight number and page count information included on each page, users can be sure that they have a complete document upon retrieving the flight release from multifunction printer 34.

The document distribution server 32 also compiles a cover sheet (part of Step 320) to the beginning of the merged flight release document that contains identifying information such as the flight number, date, origin, and destination information. In addition, the cover sheet contains a two-dimensional barcode created with the aid of barcode module 40 that comprises the same flight number, date, origin and destination information. In one embodiment, the barcode confirms to a PDF417 standard, though other standards such as RSS, Aztec, or Code 128 may be used as well. The barcode on the cover sheet of the flight release is used after the flight is completed and the user returns the flight release information into the system. Conventionally, pilots or other users hand delivered a signed copy of the flight release upon their return to a central hub or the SOC. With the embodiments disclosed herein, users are able to submit a signed flight release upon landing at the destination.

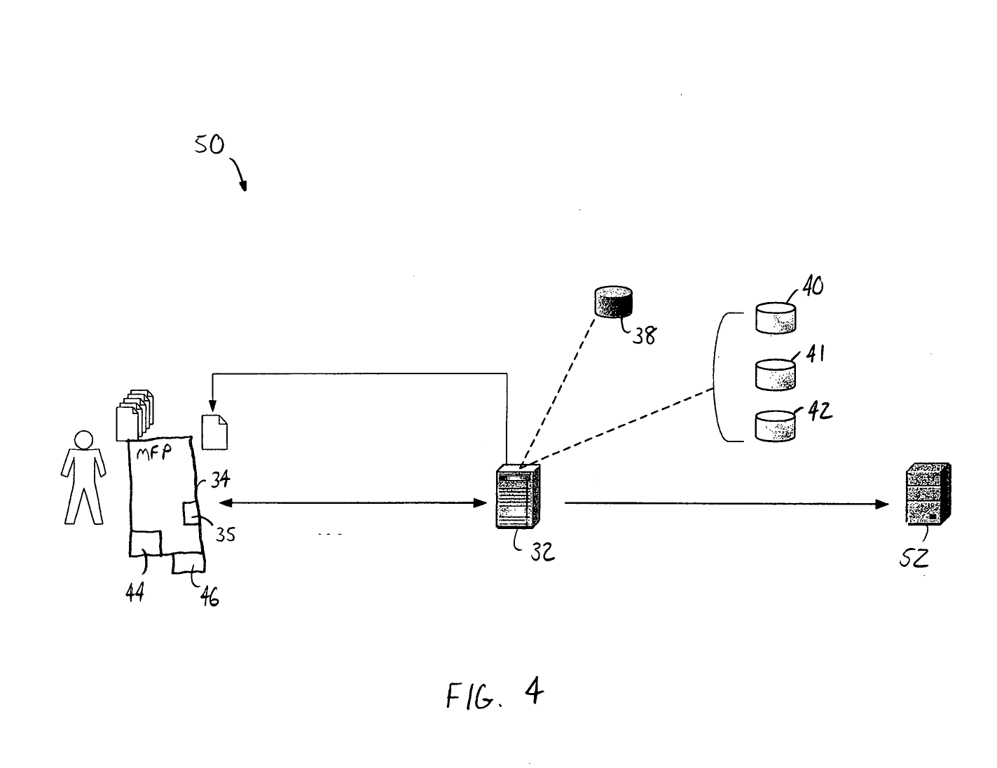

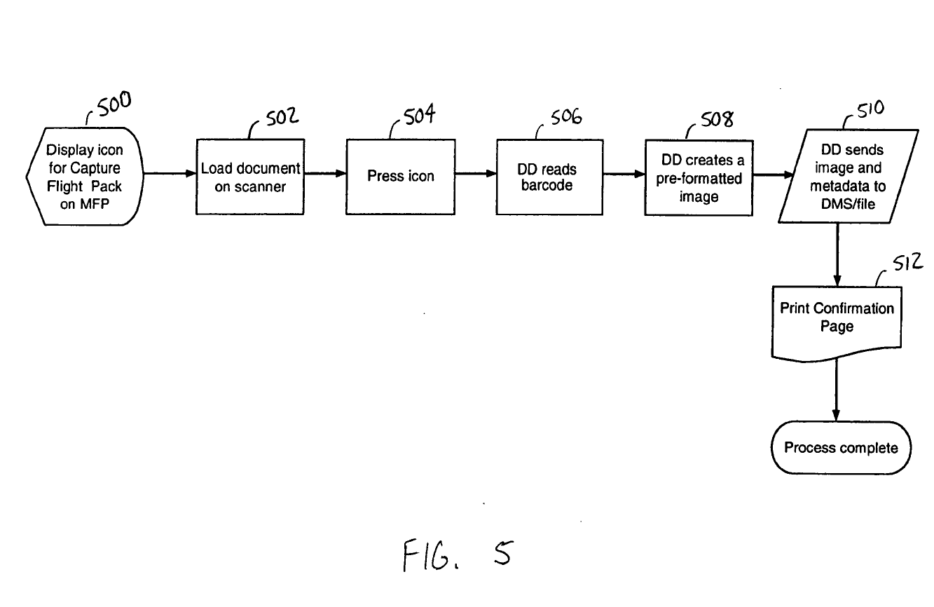

The exemplary network architecture 50 shown in FIG. 4 advantageously permits this type of remote flight release submission and capture. Items common to FIG. 2 are referenced by similar numbers in FIG. 4. That is, the multifunction printer 34, and its associated proximity reader 46 and display panel 44, and document distribution server 32 with its associated encryption services 38 and extension modules 40-42 are reproduced in FIG. 4. A document management system 52 or other file repository such as a storage area network is shown as a storage solution adapted to receive and store completed and signed flight release information. The document management system 52 may be located at the SOC 12 or some other remote location. The process for submitting a signed flight release post-flight is shown in FIG. 5.

Referring to FIGS. 4 and 5, users such as pilots or other qualified personnel sign the flight release at the destination and selects an option on display panel 44 to capture the flight release. In one embodiment, users may select this particular option by selecting an icon (Steps 500, 504) on the display panel 44 of the multifunction printer 34. Though not specifically shown in FIG. 5, the multifunction device 34 may prompt the user to scan their ID badge as described above in the flight release retrieval process shown in FIG. 3. The user places the flight release document in the document feeder on the multifunction printer 34 (Step 502) to be scanned by the multifunction printer 34 and transmitted to the document distribution server 32. The scanned data, including data representing the barcode on the cover sheet of the flight release is read by the document distribution server 32 (Step 506), which (with the aid of Barcode module 40) extracts metadata from the barcode representing the flight number, date, origin, and destination. The document distribution server 32 then creates a preformatted image in a standard format such as PDF, JPG, or TIF and delivers the image and metadata to the document management system 52. If the scanned flight release data is properly received and the data properly archived at the document management system 52, the document distribution server 32 transmits a confirmation page that is printed for the user at the multifunction printer 34.

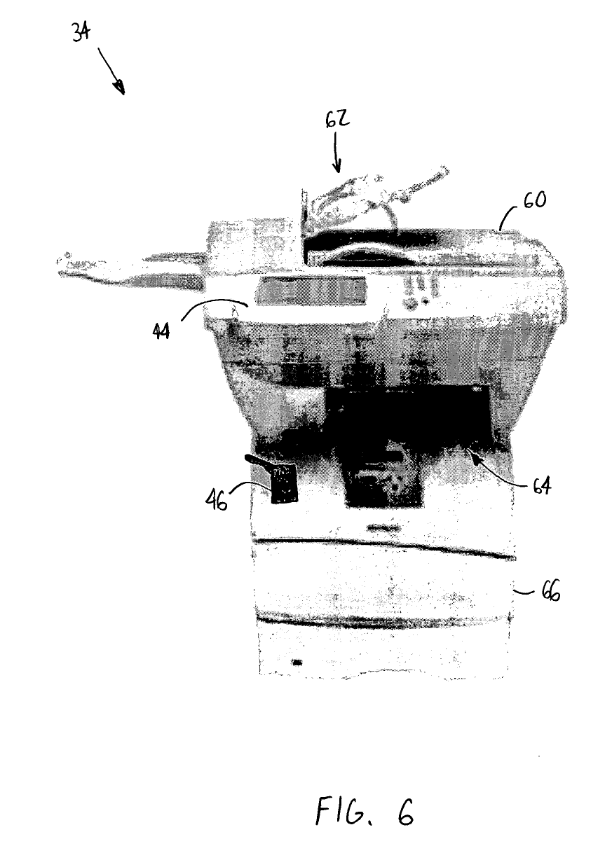

FIG. 6 shows an exemplary multifunction printer 34 that may be used in the various embodiments disclosed herein. In one embodiment, the multi-function printer 34 is from the Lexmark X630e or X830e family of multifunction printers available from Lexmark International, Inc. in Lexington, Ky., USA. The multifunction printer 34 is capable of performing a number of tasks including copying, faxing, printing, and scanning. In the embodiment shown in FIG. 6, the multifunction printer includes a media storage bin 66 for storing blank, cut media sheets on which the flight release documents are printed. The reports are retrieved from an output stack 64. The multifunction device also includes a flatbed scanner 60, though the scanning or copying function may be accessed by feeding documents into the document feeder 62.

The proximity device 46 is a sensor adapted to recognize authorized user ID badges by sensing a predetermined RF signature. The proximity device 46 is advantageously coupled to a serial data port on the multifunction device 34. Alternatively, the proximity device 46 may be coupled to a client workstation in the vicinity of the multifunction device 34. Alternative security devices may be incorporated to verify user identification. For example, biometric devices, magnetic card readers, and optical laser scanners all provide alternative recognition devices capable of providing a similar security function.

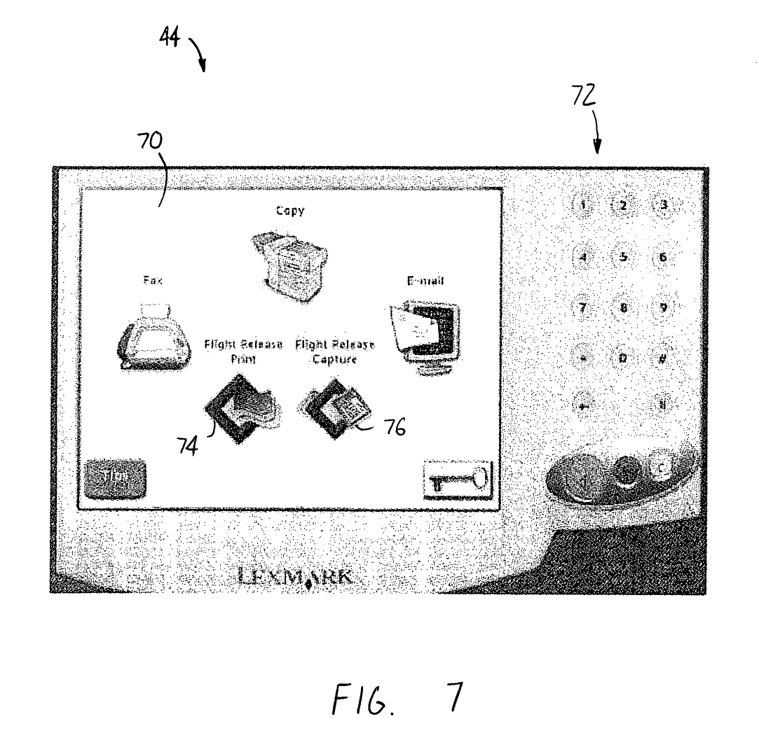

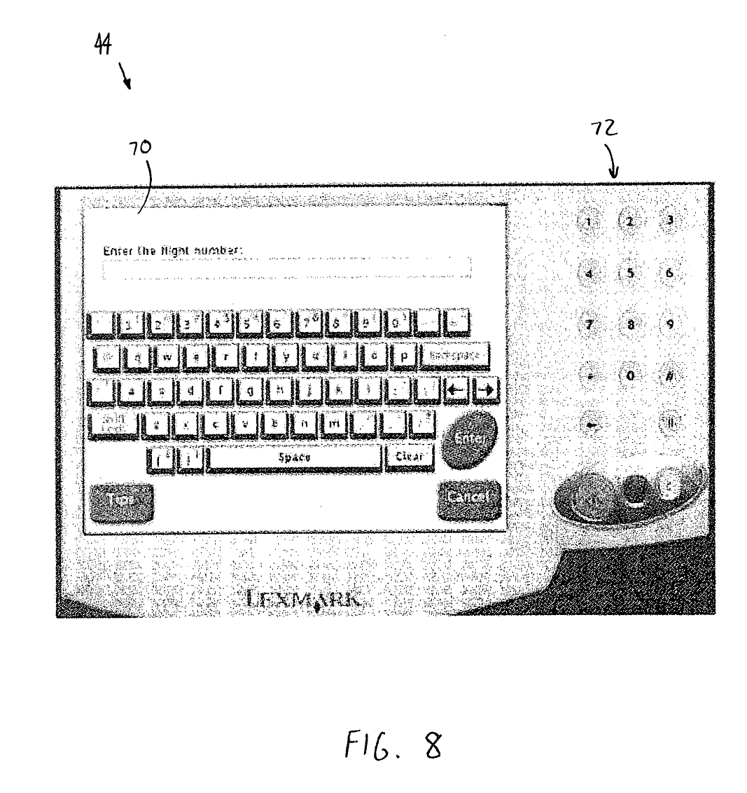

A user interface panel 44 permits user interaction with the multifunction device 34 and provides access to the various functions described herein. FIG. 7 shows an exemplary view of the user interface panel 44 of the multifunction device 34. In the embodiment shown, the user interface panel 44 comprises a LCD touch screen 70 and a numerical keypad 72. The LCD touch screen 70 depicted in FIG. 7 shows a main menu screen providing access to some of the functions of the multifunction device 34, including fax, copy, and E-mail operations. In addition, two icons 74, 76 representing flight release print and capture functions, respectively, are included to allow authorized users to access the aforementioned printing and capturing features. A subsequent screen shot of the LCD screen 70 provided in FIG. 8 shows a virtual keyboard, which allows users to enter relevant flight or identifying information such as a flight number or password. Those skilled in the art will recognize that other screen and interface features may be used depending on the nature of the particular device used.

Those skilled in the art should appreciate that the multifunction device 34 and servers 32, 20, 52 shown in the Figures for implementing the present invention may comprise hardware, software, or any combination thereof. For example, processing circuitry 35 for prompting a user for identification may be a separate hardware circuit, or may be included as part of other processing hardware. More advantageously, however, the processing circuitry 35 in the multifunction device 34 or servers 32, 20, 52 is at least partially implemented via stored computer program instructions for execution by one or more computer devices, such as microprocessors, Digital Signal Processors (DSPs), ASICs or other digital processing circuits included in the devices 32, 34, 20, 52. The stored program instructions may be stored in electrical, magnetic, or optical memory devices, such ROM and RAM modules, flash memory, hard disk drives, magnetic disc drives, optical disc drives and other storage media known in the art.

The present invention may be carried out in other specific ways than those herein set forth without departing from the scope and essential characteristics of the invention. For instance, the embodiments described have been depicted in use with an LCD touch screen 70 on a user interface panel 44 of a multifunction device 34 to access the desired functions. Other embodiments may assign the desired functions to existing buttons of a keypad on a user interface panel. It is also possible to initiate the desired functionality via a menu tree that is viewable on a limited text display and accessed using keys and buttons on the interface panel. Still another possibility is the use of LCD touch screen that is not physically a part of the multifunction device, but that is still in communication with the multifunction device. The present embodiments are, therefore, to be considered in all respects as illustrative and not restrictive, and all changes coming within the meaning and equivalency range of the appended claims are intended to be embraced therein.

What is claimed is:

1. A computer readable medium which stores computer-executable process steps for creating flight release information, said computer-executable process steps causing a computer to perform the steps of:
determining that a user is authorized based on inputted identification;
prompting the user for a flight specific data item;
validating the flight specific data item;
locating relevant flight information; and
creating a flight release document containing the relevant flight information.

2. The method of claim 1 wherein the step of prompting the user for a flight specific data item comprises prompting the user for a flight number.

3. The method of claim 1 further comprising determining that the flight specific data item is not valid and prompting the user to input another flight specific data item.

4. The method of claim 1 further comprising printing the flight release document at the user location.

5. The method of claim 4 further comprising printing a specific page number and a total page count on each printed sheet of the flight release document.

6. The method of claim 4 further comprising printing a barcode containing metadata related to the flight release document.

7. The method of claim 1 further comprising including static and dynamic information within the flight release document.

8. The method of claim 1 further comprising retrieving a plurality of text files from a file transfer protocol server.

9. A computer readable medium which stores computer-executable process steps for capturing completed flight information, said computer-executable process steps causing a computer to perform the steps of:
prompting the user for identification at a flight destination location;
determining that a user is authorized based on the inputted identification;
prompting the user for the completed flight information;
receiving the completed flight information; and
sending the completed flight information to a central hub.

10. The method of claim 9 wherein the step of receiving the completed flight information comprises scanning the completed flight information.

11. The method of claim 10 further comprising scanning a barcode on the completed flight information.

12. The method of claim 9 further comprising printing a confirmation at the flight destination location.

13. A computer readable medium which stores computer-executable process steps for controlling flights, said computer-executable process steps causing a computer to perform the steps of:
at a flight origination location, determining that a user is authorized based on inputted identification;
prompting the user for a flight specific data item;
validating the flight specific data item;
locating relevant flight information;
creating a flight release document containing the relevant flight information;
printing the flight release document at the flight origination location;
at a flight destination location, prompting the user for identification; and
receiving and storing the flight release document.

14. The method of claim 13 wherein the step of locating the relevant flight information comprises locating weather information.

15. The method of claim 13 further comprising printing a specific page number and a total page count on each printed sheet of the flight release document.

16. The method of claim 13 further comprising printing a cover sheet having a barcode containing metadata related to the flight release document.

17. The method of claim 13 wherein the step of receiving the flight release document comprises scanning the flight release document.

18. The method of claim 17 further comprising scanning a barcode on the flight release document.

19. The method of claim 13 further comprising printing a confirmation at the flight destination location.

20. The method of claim 13, further comprising creating the relevant flight information prior to receiving a request.
